(19) United States
(12) Patent Application Publication
(10) Pub. No.: US 2005/0117816 A1
(43) Pub. Date: Jun. 2, 2005

(54) Virtual microscope-device and method

(76) Inventors: Kai Saeger, Berlin (DE); Karsten Schluns, Berlin (DE); Peter Hufnagl, Berlin (DE); Manfred Dietel, Berlin (DE)

Correspondence Address: ROTHWELL, FIGG, ERNST & MANBECK, P.C., 1425 K STREET, N.W., SUITE 800, WASHINGTON, DC, 20005, US

(21) Appl. No.: 10/508,207

(22) PCT Filed: Mar. 10, 2003
(86) PCT No.: PCT/EP03/02443

(30) Foreign Application Priority Data
Mar. 18, 2002 (DE) 10213069.8
May 31, 2002 (DE) 10215174.6

(51) Int. Cl. G06K 9/40; G06K 9/54

(52) U.S. Cl. 382/305; 382/254

(57) ABSTRACT

The invention relates to a virtual microscope system consisting of digital image data (31) of a preparation which is scanned image capture system with predefined magnification and a predefined detail or otherwise imported; a server system (2) with software (231) for generating a virtual profile (212) of the preparation from the digital image data (31) of the preparation which is provided by the image capture system or otherwise imported; software (232) for image processing of the virtual profile (212) and a storage device (21) which is used to store the virtual profile (212) in a case data bank (222); and at least one client system (1) with application software (11) for the representation of data of a selective virtual profile (212) from the case data bank (222) which can be selected by a user (13). In order to fully replace a conventional microscope with regard to the image representation thereof, the image data (31) of the preparation provided by the image capture system and the virtual profile (212) generated by the server is an image of the preparation with the highest available or desired degree of magnification and represents the highest available or desired profile of the preparation, particularly a general view. Functions such as the transmission of image data in real time, continuously variable zooming, the generation of multilayer images, a marking plane, processing of said images by means of image processing, case data management and protocolling et al. can be provided for any specific number of on-line clients.

The present invention relates to a virtual microscope system including digital image data of a preparation which is scanned at a definable magnification and in a definable section by an image recording system or is otherwise imported; a server system having software for generating a virtual profile of the preparation from the digital image data of the preparation provided by the image recording system or otherwise imported, software for image processing of the virtual profile, and a storage device for storing the virtual profile in a case database; and at least one client system having application software for representing data of a selectable virtual profile in the case database selectable by a user. The present invention also relates to a method for processing digital microscope data as recited in claim 36.

To assess objects, such as histological preparations, processor circuits, or other medical preparations or technical components with significant magnification, light-optical microscopes are typically used. Light-optical microscopes may be further classified according to the type of preparation illumination (reflected light microscope or transmitted light microscope), wavelength of the illumination light (simple light-optical microscope or fluorescent microscope), oscillation direction of the illumination light (polarization or interference contrast microscope), as well as the phase position of the detected light (phase contrast microscope or dark field microscope). All light-optical microscopes are limited with respect to resolution as a result of the wavelength of the light and therefore have a minimally distinguishable point distance of approx. 0.2 micrometers (0.2×10⁻⁶ m). Under consideration of the minimum point distance discernible by the human eye of approx. 0.2 millimeter, this means a maximum possible magnification of approximately 1,000 times. Higher resolution is achieved using electron microscopes. In this case, the preparation is bombarded with the significantly shorter wave electrons instead of with light wave, and their deflection as they pass through the preparation is detected. As a result, a resolution having a point distance of approx. 2 angstroms (2×10⁻¹⁰ m) is able to be achieved in theory. However, as a result of the limited achievable lens quality, a visible enlargement of only approx. 300,000 times is actually possible. Electron microscopes differ according to the type of beam path (transmission microscope or scanning electron microscope).

All of these devices are subject to the following limitations:
Only one section may be viewed at one time.
Only a few specific lens-dependent magnification levels are available.
Preparations may only be viewed one at a time.
It is not possible to make marks on the local microscopic level.
Content-related presentation is not possible.
Only one local viewer is possible at a time.
A preparation is only available once and is not able to be duplicated.

The ability to comment on a case is also very limited. Notes or comments regarding the image are typically made in writing or are spoken into a dictation device. It is not possible to link notes to concrete sites on the preparation in a clear manner without auxiliary devices (for example, scanning table and software). The user must generally make a note of the sites of interest. It is not possible to send a case in digital form or to assess an object at a spatial distance from the microscope without special auxiliary devices (e.g. a TV camera).

Various auxiliary components addressing individual technical limitations of a microscope have be developed in the past to improve the functionality of such microscopes. As a result, a “multi-view device” allows a plurality of persons to view a preparation simultaneously via a beam-splitting lens to be attached to the microscope. The narrow field of view is able to be expanded by a special ocular lens (large-field lens). Video cameras including a monitor allow a plurality of persons to view the preparation at the same time but with very limited quality. The generation of digital images of an individual section and their duplication have also been achieved using a video camera and a computer connection. Finally, a number of telepathology systems allowing the live transmission of the microscope image to a remote user as well as remote control of the microscope by this remote user have been available for several years.

In the beginning, digital methods for supporting microscopes were also created. As a result, the creation of digitalized microscope images, known as virtual profiles (VP), via computer-controlled microscopes is known from WO 98/39728, for example. In this context an overview image comprised of a plurality of partial images and having low resolution is recorded and the partial images are linked to a common, coordinate-based data structure and stored. The user may subsequently select regions of interest in which the data is measured at a certain higher resolution or magnification level and are also stored in a coordinate-based manner. The data structure described in this document does not provide for the provision of a total image of the preparation at a higher resolution. It is also not possible for the user to generate multi-layer images, to use a drawing plane, or to perform continuously variable zooming.

It is known from WO 01/54052 to store the data of a virtual profile on a server and to visualize this on the client side via a Web browser in the form of an overview image at a low resolution and callable partial images at a higher resolution, switching back and forth between the different resolutions being provided. A total image at the highest resolution is also not provided in this instance. Moreover, it is not possible to use multi-layer images and a drawing plane. There is also no continuously variable zooming or user data and case data management.

WO 99/47964 describes special techniques for scanning a preparation.

Finally sending the virtual profiles as a data structure via the Internet and intranet is known from WO 01/26541. Live discussion of a case by a plurality of users via the Internet is also known from telepathology.

In conclusion, a system which could completely replace a microscope (apart from image recording and scanning) is not yet available. Such a system would be desirable since it would combine all advantages in one solution, would be less expensive and more convenient, and would also render possible functions urgently desired by microscope users. Such functions include, for example, the use of multi-layer images, the use of a marking plane, automatic case management for workflow automation, automatic image processing for supporting and accelerating the work of a microscope user, as well as continuously variable zooming.

Thus, the present invention is based on the object of providing a virtual microscope which completely replaces all functions of a conventional mechanical light-optical or electron microscope, with the exception of the actual image recording function, and also provides several additional functions previously unknown in the mechanical solution. Furthermore, the virtual microscope is to overcome the known limitations of today's digital microscope and render possible real-time remote transmission of image data in particular. A suitable method for processing digital microscope data is also to be provided.

The object is achieved by a virtual microscope having the features of claim 1 and a method as recited in claim 36. The virtual microscope of the present invention is characterized in that the digital image data of the preparation which is transmitted by the image recording system, e.g. a light-optical or electron microscope, or is otherwise imported (for example from PACS) or the virtual profile on the server side generated from this data is an image of the preparation at the highest available or desired magnification and in the greatest available or desired section of the preparation, in particular a general view of the preparation.

According to the present invention, the database therefore includes only one digital microscope image of each preparation at a single, i.e. maximum, magnification. In this context, high or low magnification refers to a representation on the user side at a high or low resolution as is typical when representing digital images on monitors. In this manner, a user is always able to access virtual profiles directly from a client station without new microscopic measurements having to be performed in the region of interest at the desired magnification, for example.

The basic principle of the present invention is therefore the scanning of a whole preparation at the highest available or necessary magnification to form a total image, its representation in an Internet or intranet-based or independent user interface, and the processing of the case using new digital tools in a client-server environment. The complete object slide is digitalized at the highest magnification and is stored on a computer (server) as an electronic file (virtual profile). The image may come from a digital camera installed at a microscope (possibly remote-controllable), imported digital images, another image recording system, or a PACS (picture archiving and communications system). The image data is preferably available in a compressed form since very large data quantities are to be handled. The image may be loaded onto the system via Internet or intranet protocols (such as TCP/IP) or a fixed data carrier (such as a CD ROM). The virtual microscope system which visualizes specifically the desired preparation section or also the entire preparation on a computer monitor of a client system is used for viewing the virtual profiles (VS). Control operations are performed via an interactive input medium (for example, a mouse, joystick, touch pad, etc.) by the user.

Assessing objects at significant magnification in digital form results in significant time-related and functional improvements. Once an object has been digitalized via a suitable image recording system (for example, using a conventional microscope having a scanning table and digital camera), the system of the present invention allows the image to be available to any desired user, even a plurality of simultaneous users, via an intranet or the Internet. The digital image may be superimposed by an additional layer (marking plane) on which comments or notes may be made or sites of interest may be marked. In addition, the digital form renders possible continuously variable zooming and shifting as well as-various image processing methods.

According to a particularly advantageous embodiment of the present invention, the application software of the client system includes a viewer in which the general view of the preparation is represented as an overview image having low resolution and/or at least one image region currently selected by the user is represented as a detailed view at higher resolution. Preferably, the overview image which displays the entire preparation and preferably the region of the selected section marked thereon is constantly represented in addition to the representation of the selected preparation section. A plurality of sections may also be viewed simultaneously. The resolution may be freely set by the user in the overview image as well as in all detailed views.

Furthermore, means via which exactly one image region of the selected virtual profile selected by the user from the case database of the server system is currently requested and displayed on the client side in the viewer are advantageously provided in the client system. The data may optionally also be loaded to the client server system via mobile data carriers (for example, CD ROM). The highly compressed image data generated by the software for generating virtual profiles and preferably available in the enhanced compressed wavelet format (ECW, format of Earth Resource Mapping) allows the quasi real-time transmission and representation of the selected region. In this context, only the data of the image region of interest is transmitted in each case at the compression level of the resolution of interest from the server system to the client system, decompressed on the client side via decompression software, preferably in the form of an Earth Resource Mapping plug-in suitable for the compression format, and represented with the desired size in the viewer.

Since the total image of the preparation is available at the highest resolution in the form of the virtual profile, a continuously variable digital zooming function allowing a detailed view within any site in the general view of the virtual profile up to the highest magnification (or resolution) is achieved according to the present invention. For this purpose, the user places, manually for example, a tracker provided in the general view or the detailed view to specify the position and expansion of the desired sub-region whereupon the client system requests the necessary image data from the server system and represents it as a new detailed view. In this context, the representation of a section or image at a low magnification corresponds, as is typical in digital zooming, to the representation of the image at a low resolution. As a result, a preparation is able to be displayed in a continuously variable manner at every magnification level. The zooming is performed in real time so that the user is able to set the optimum magnification level interactively. The tracker may also be used for sampling the virtual profile via manual shifting.

A particularly advantageous embodiment of the present invention shows the possibility for using multi-layer images made up of a plurality of superimposed total images of the same preparation, measured for example using different colorings or recording techniques. Multi-layer images are known in principle. A multi-layer image in this context is an image data set including a plurality of images of the same object within one file which are geometrically adjusted with respect to one another. This allows the VM user actual simultaneous viewing and as such direct and quick visual comparison of two or more images of an object as was not previously possible using currently available microscopes and digital solutions with respect to the total image of the preparation. Simultaneous visualization of images is achieved by dividing the detailed view, quickly and simply switching the view, or also via semi-transparent viewing of a plurality of preparations having the possibility at the same time of adjusting the transparency. The geometric adjustment of the images (matching) with respect to one another is performed within an image processing module on the server.

In this context, it is preferably possible in particular to represent a plurality of detailed views at the same time, the detailed views being representable in particular at different magnifications and/or with different coloring and/or at different locations and/or as different zoom representations.

A further significant advantage of the present invention is that the image or multi-layer image is superimposed by a marking plane on which the user is able to make image coordinate-based comments, markings, and/or the like. This allows marking of sites or regions of interest, entering of image coordinate-based texts, symbols, graphics, drawings, markings, hyperlinks, references to other data (e.g. audio data), and drawing, even freehand, in the image, as well as the linkability of marked sites and additional preparation information as needed. In addition, the marking plane may include markings of image regions viewed during image analysis and/or of an inspection path which represents a path through the preparation inspected by the user. The marking plane may be optionally displayed or may be invisible. It is also possible to store the marking plane together with the virtual profile permanently in the case database.

According to a preferred embodiment of the present invention, the software for generating virtual profiles which is installed on the server system includes an import function which allows the import of image data provided by the recording system in any image data format. The image data formats are then converted by the software into the compressed image format (in particular in ECW format), a color depth being able to be variably defined. The image data of a virtual profile is stored in this form. In addition to the actual image data, the virtual profiles stored in the case database include further information, in particular status data of the case, preparation and recording parameters, and/or the like, this text data preferably being available in a SQL structure (structure query language, a diverse query format for databases). The text data may be entered by an operator of the recording system and/or by a user on the client side via typical input means.

A further particularly advantageous embodiment of the present invention provides for server-side provision of software or a software packet for image processing of virtual profiles which may be started by the server system automatically, according to the case type after generation of the virtual profile, or be performed individually by a user, the image processing including one or more of the steps:
Contrast improvement
Normalization of the brightness distribution
White balancing
Edge extraction
Matching to known structures for preselection of regions of interest
Structure measurement and counting
   and/or additional functions. According to further preferred embodiments of the present invention, such image processing functions may also in particular be simulation of illumination situations, in particular simulation of at least one bright field and/or dark field, and/or polarization and/or incident light and/or transmitted light and/or phase contrast or the like. Furthermore, the image processing function may be a simulation of color situations, in particular generation of mixed coloring as a combination of real colorings and/or color change. The image processing steps may either be called up by a user or automatically started according to the particular case type. A list of image processing steps may be created for relevant case types so that the system automatically starts defined steps according to the current case type. Image processing is used for automatically emphasizing structures which support the user in subsequent analysis of the image or direct the user in a targeted manner to relevant structures (e.g. mitoses in tumor preparations).

A further advantageous embodiment of the present invention provides means for managing the case, image, and user data. In this context, in addition to the case database in which all case data, image data, and status data of a case are stored in a structured manner (for example, using SQL), there is a user database in which access data, access rights, and case allocations are stored. The server system on which these databases are stored ensures secure, redundant storing of the data (for example, via a RAID system). The careful configuration of these two databases first makes it possible to replace a conventional microscope completely with the virtual microscope system. This also includes detailed protocolling of the workflow and the work of the user.

Another preferred embodiment of the present invention provides for the access control of users to the server system to include means for encoding/decoding and/or means for checking access authorization, in particular as a digital signature. This allow secure authentication during user accessing.

The system of the present invention also includes a conference mode between the client systems, a control change, in particular a master-slave allocation, being possible in particular between the client systems and/or the client system and the server system. As a result, live discussions, in particular audio-visual live discussions are advantageously possible between the client systems and/or the client system and the server system.

The method of the present invention for processing digital microscope data includes the following steps:
a. Scanning or otherwise importing digital image data of a preparation at a highest available or desired magnification and in a greatest available or desired section of the preparation by an image recording system;
b. Generating a virtual profile at the highest available or desired magnification and in the greatest available or desired section of the preparation from the image data of the preparation which is provided by the image recording system or is otherwise imported via a first software of a server system,
c. Changing the virtual profile via image processing functions of a second software of the server system,
d. Storing the virtual profile in a case database of a storage device, and
e. Representing data of a selected virtual profile of the case database selected by a user of at least one client system via an application software.

Further advantageous embodiments of the present invention are the object of the remaining dependent claims.

The present invention is subsequently described in greater detail on the basis of the corresponding drawing. The figures show:

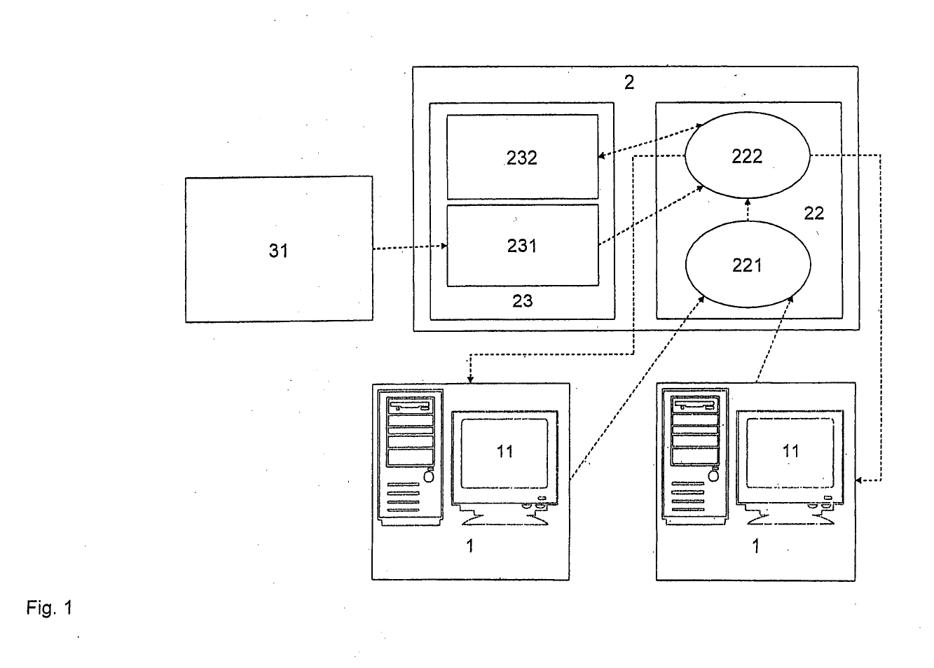

FIG. 1 schematically shows the data flow of the entire system of a virtual microscope;

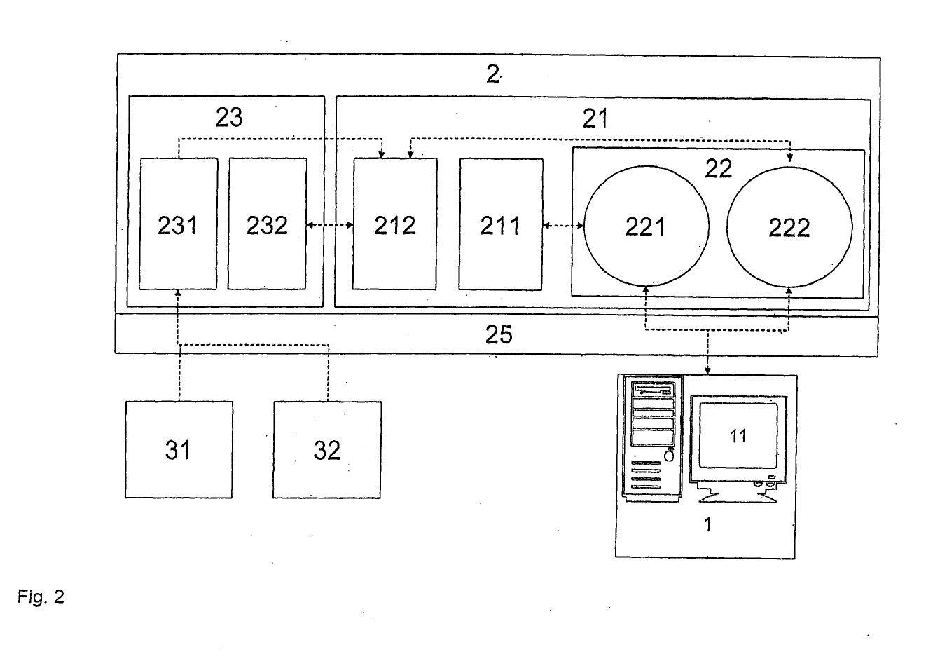

FIG. 2 schematically shows the mode of operation of the server system within the total system; and

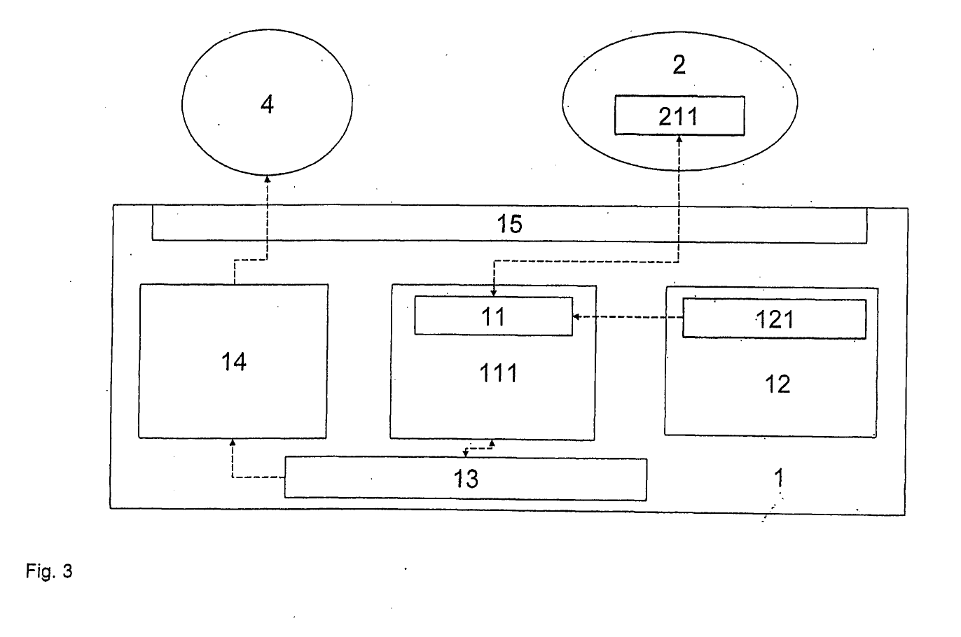

FIG. 3 schematically shows the mode of operation of a client system within the total system.

According to FIG. 1, the virtual microscope of the present invention is a client server-based system. It includes the two main components consisting of at least one client system 1 and a server system 2, a client 1 also being able to be installed together with server system 2 on the same computer.

Server system 2 includes a storage system 21 (FIG. 2) on which all virtual profiles 212 of a case are stored. Server 2 also provides server software 23, in particular a software 231 for generating virtual profiles 212 and a software 232 for image processing of virtual profiles 212.

All computer stations communicating via the Internet or an intranet with server system 2 and operated by users 13 (FIG. 3) of the system are included in client system 1. Any number of client systems 1 may be available and may access server 2 at the same time. For communication and data transmission purposes, every client system 1 has an interface 15 and server system 2 has an interface 25, which are preferably TCP/IP interfaces. An application software 11, which is able to run on every client system 1, is required on the client side for requesting, representing, and assessing a virtual profile 212. According to the represented example of server system 2, application software 11 is provided in a Web browser 111. However, application software 11 may optionally also be provided as an independent program interface or within a user interface of another software in client system 1.

The following describes several individual components of the server and client system in greater detail.

Server

Server system 2 is made up of storage system 21, which is a read only memory in particular and includes a database module 22, software 23, and interface 25.

Database module 22 has the following tasks:
Storing the digital images recorded by an image recording system in the form of virtual profiles 212 in a case database 222;
Operating server software 23 via which the images and data may be viewed and modified;
Managing the image and text data in databases 22;
Controlling access via a user access database 221, which manages registered users 13 and their access rights.

The image data is stored in a special image format which allows high compression (preferably in ECW format). The described data and case data (212) are managed in a SQL-based manner. This facilitates the finding of specific cases on the basis of all recorded parameters.

Server system 2 also includes several software components 23. These include:

1. Application software 11, which may be transmitted to Web browser 111 or as an independent program of a user 13. This application software 11 is used as the user interface. It includes a first display window in which an overview image of virtual profile 212 is represented and via which navigation is possible in the virtual profile, another display window which displays a currently selected image section, and a plurality of control tools used for navigating in the image, for processing the case data, and for managing the data. This application software may alternatively also be loaded on the client side from a fixed data carrier (for example, a CD ROM).

2. A program 231 for generating virtual profiles 212. The program is necessary for formatting digital image data 31 of an image recording system into a virtual profile 212, which is then stored in case database 222. A virtual profile 212 is initially made up of image data, multi-layer data also being possible, and some data 32, such as case numbers, recording date, and the like which is entered interactively by user 13 or is imported via an interface from another database system (e.g. hospital information system or PACS). However, the data of such a virtual profile 212 increases as the case is processed since various comments, markers, and the like are subsequently added. Therefore, program 231 for generating virtual profiles 212 has the task of reformatting the transmitted image data into the special image format of a virtual profile 212, combining partial images to form a total image if necessary, or matching a plurality of image layers together such that they have a common, geometric, for example coordinate-related basis. In addition, the data provided by user 13 must be entered into the format of virtual profile 212. The virtual profile generation proceeds as follows:
Digital image data 31, which is provided by the image recording system in raw, tiff, jpg, or another format, is first loaded;
Various image processing steps are applied in a defined sequence according to the case type (preparation-dependent);
The color is adjusted to a defined color depth (e.g. 16 bit=2×5 bit+1×6 bit);
A reformatting operation to a compressed image format (e.g. ECW) is subsequently performed;
If available, superimposition and geometric matching of additional image layers are performed to form one multi-layer image;
Additional information from interaction with user 13 is applied;
Case number, processor, status, case type are created;
All image and text data is stored as a virtual profile 212 in case database 222.

3. A software 232 for image processing of virtual profiles 212. This may include all methods of image processing which may be used for digital images to automatically emphasize structures which support user 13 in subsequent assessment of the image. Such methods include, for example:
Contrast improvement,
Normalization of the brightness distribution,
White balancing,
Edge extraction,
Matching to known structures for the preselection of regions of interest,
Detecting, measuring, and counting objects and structures,
Various others.

The image processing steps may either be called up by a user 13 or started automatically according to the particular case type. A list of image processing steps may be created for every case type in use so that the system automatically starts defined steps according to the current case type.

Finally an interface 25, via which server 2 may be connected to client systems 1, is also part of server system 2. This is preferably implemented via TCP/IP.

Client

Application software 11 is controllable on user side 1 via a Web browser 111 or runs as an independent user interface and is consequently independent of the system. The viewer for large image files is provided on user-side Web browser 111 or the independent program interface. The image data is stored entirely on the server side. In this context only the image data of interest is transferred from the server system to the client system and decompressed. The special format for the image data ensures high compression without visible quality loss with quick access to individual regions within the image file. A high compression rate is particularly important for the large size of the image data. The quick access to the image data allows zooming and sampling of the images almost in real time. The software is accessed via a login, in order to control access rights and protect the data. As a result, each user is granted access only to certain data and has certain administrative rights for every data type (for example create, read, modify, delete).

Application program 11 of client system 1 may include a series of the following functions, points 1a through 1g, 2h, 3l, 4p, and 7x through 7z representing particularly preferred basic functions, points 2i and 2j, 3m and 3n, 4q and 4r as well as 6v representing advantageous practical main functions, and points 2k, 3o, 4s, 5t, and 5u, 6w as well as 7aa representing optional functions having a purely auxiliary function:
1. Image movement may be achieved using variable input devices, the following functions being provided:
   a. Continuously variable moving of the image (interactive);
   b. Continuously variable zooming of the image (interactive);
   c. Shifting of the image by a certain amount (semi-automatic);
   d. Adjusting of a certain magnification level (semi-automatic);
   e. Selecting of an image section via a selection rectangle in the overview image (semi-automatic)
   f. Selecting of an image section via a selection point in the overview image (semi-automatic) and/or
   g. Selecting of an image mark (see below) (automatic).
2. Image documentation via a marking plane includes the options:
   h. Inserting of image marks (interactive);
   i. Inserting of text or symbols (interactive);
   j. Inserting of graphics or freehand drawing (interactive) and/or
   k. Inserting of references or links (interactive).
3. An intelligent search of images or image regions includes:
   l. Search for markers (automatic),
   m. Search for text content of the marking plane (automatic),
   n. Search for case data (automatic) and/or
   o. Search for image content (structures, textures, forms, colors) (semi-automatic).
4. In addition, the following measurement functions may be provided:
   p. Automatic counting of structures (automatic),
   q. Segment calculation including specification of the segment on a real scale (automatic),
   r. Surface calculation including specification of the surface on a real scale (automatic) and/or
   s. Classification of textures or colors (semi-automatic).
5. Additional image processing functions may include:
   t. Matching of a plurality of image layers (geometric adjustment of images of the same object using different coloring or recording technique) (automatic), and/or
   u. Comparing of a plurality of image layers (subtraction image) (automatic).
6. Additional functions may include:
   v. Snapshot (storing of partial images) (automatic) and/or
   w. Track history (registering of viewing path) (automatic).
7. The following may be provided as management functions:
   x. Inputting of an assessment (interactive),
   y. User management (semi-automatic),
   z. Case data management in the database (semi-automatic) and/or
   aa. Tracking of a case along the entire workflow (automatic).
      User Interface

The user interface runs within a Web browser 111 or an independent program. The program window (viewer) within the browser or program window is preferably divided into six regions. These six regions are not required to always appear simultaneously. Rather, the user may activate, deactivate, and arrange the desired interface elements.

1. Menu Bar

The menu bar includes controls for all functions provided by the virtual microscope. In addition, the management of a case may be controlled via the menu bar and all options and system attributes may be set and modified.

2. Overview Image

The overview image initially displays the entire digital preparation (virtual profile). During the course of the assessment, it is used for selecting a new image view and for representing the currently displayed image region. A tracker, i.e. a rectangle, the edges of which match the edges of the image in the image view, appears in the overview image for this purpose. Using different functions, a new image view may be selected via the tracker. However, the overview image may also be used to display a partial view as desired.

3. Control Elements

The control elements include different graphic control elements to facilitate navigation in the image. The mouse is used here for control. Alternatively, other input devices (joystick, touch pad, etc.) or the menu bar may also be used to navigate.

4. Image View

The image view shows the current partial image selected via the overview image or in another manner. Based on this image, user 13 is able to assess a preparation. The overview image is navigable in different ways. This may occur via the mouse, the control elements, the overview image, or other input devices. In addition, other image layers or the marking plane may be displayed in the image view, optionally also as a semi-transparent representation. A context menu via which location-based functions (for example the setting of a marker) may be activated is available via the mouse.

5. Status Line

The status line shows program information for the user, such as progress bars, program status, etc. in one line.

6. Image List

The image list is a table of small partial images which compose the essential components of the virtual profile or also a table of overview images of all virtual profiles of one case. It is possible to select an image and to switch to the image view via control elements.

Input Devices

Devices via which a user may interact with the PC or input data are designated as input devices. This input is necessary during user interactions (use of control tools) or during data input. The possible input devices are presented in the following table, particularly preferred basic functions being represented by points 1 through 4, advantageous practical main functions being represented by point 5 and optional functions having a purely auxiliary function being represented by points 6 through 8:
1. Image recording system
   System for digitalizing image data
2. Keyboard
   For data entry and control
3. 5-button scroll mouse
4. Interface (e.g. HL7 or DICOM interface)
   For importing data from other database systems
5. Joystick
   Tool for precisely moving an image. Also used for selecting menu points or activating buttons and similar control elements.
      6. Microphone
   For data input (speaking audible comments, in connection with voice recognition software for inputting text data) and controlling (direct command entry via voice recognition, e.g. “Zoom out!”, menu and user interface control via voice recognition, e.g. “Open file drive A!”).
7. Dataglove (glove having motion sensors for direct control of a mouse pointer/image on the screen). Control tool for moving images on the screen, activating menus or buttons and similar control elements or also for moving 3D objects.
8. Gesture recognition (camera having software for recognizing gestures and hand movements. Recognition of line of sight also conceivable). Control tool for moving images on the screen via hand motion or simply by looking, activating menus or buttons and similar control elements on the screen by pointing or simply looking.

Additional usable, optional input devices are a trackball, touch screen, and/or touch pad.

Output Devices

Output devices are devices via which a user is able to view computer data. This includes devices via which a remote third party is able to view the data. The possible output devices are summarized in the following table, particularly preferred basic functions again being represented by points 1 through 3, advantageous practical main functions being represented by points 4 and 5, and optional functions having a purely auxiliary function being represented by point 6:
1. Monitor (also a touch screen)
2. Modem or network card
   For sending a case or parts thereof (e.g. individual images) to remote users via fax, e-mail, or direct connection (TCP/IP)
3. Interface (e.g. HL7 or DICOM interface)
   For exporting data to other database systems
4. Loudspeaker
   For outputting spoken comments and for communicating live discussions
5. Printer
6. Video projector.
   List of Reference Numerals
1 Client system
   11 Application software
      111 Web browser or independent software user interface
   12 Storage system
      121 Access data
   13 User
   14 Access software on external databases
   15 TCP/IP interface
2 Server system
   21 Storage system
      211 Access data
      212 Virtual profile
   22 Databases
      221 User database
      222 Case database
   23 Server software
      231 Software for generating virtual profiles
      232 Software for image processing of virtual profiles
   24 External software
   25 TCP/IP interface
3 Input data
   31 Digital image data of a preparation
      32 Case data of a preparation
4 External databases

1. A virtual microscope having
a. Digital image data (31) of a preparation which is scanned in by an image recording system at a definable magnification and in a definable section or is otherwise imported,
b. A server system (2) having a software (231) for generating a virtual profile (212) of the preparation from the digital image data (31) of the preparation which is provided by the image recording system or is otherwise imported, a software (232) for image processing of the virtual profile (212), and a storage device (21) for storing the virtual profile (212) in a case database (222), and
c. At least one client system (1) having an application software (11) for representing data of a selectable virtual profile (212) of the case database (222) selectable by a user (13),
wherein
the digital data (31) of the preparation provided by the image recording system and the virtual profile (212) generated on the server side are an image of the preparation at the highest available or desired magnification and in the greatest available or desired section of the preparation.

2. The virtual microscope as recited in claim 1, wherein the greatest available or desired section of the preparation is a total view of the preparation.

3. The virtual microscope system as recited in claim 1, wherein the software (231) for generating the virtual profiles (212) includes a function for reformatting the digital image data (31) provided by the image recording system to a compressed image format, and the virtual profiles (212) are available in the compressed image format in the case database (222), in particular in enhanced compressed wavelet format (ECW).

4. The virtual microscope system as recited in claim 1, wherein the application software (11) of the at least one client system (1) includes means via which exactly one image region of the selected virtual profile (212) selected by the user (13) is requested at a compression level corresponding to a selected resolution from the case database (222) of the server system (2) or is loaded from a mobile data carrier and represented.

5. The virtual microscope system as recited in claim 1, wherein the application software (11) includes a viewer in which the total view of the preparation and/or the image region currently selected by the user (13) can be represented as a detailed view.

6. The virtual microscope system as recited in claim 1, wherein the application software (11) includes a continuously variable digital zoom function via which a detailed view of any location within the total view of the virtual profile (212) selected by the user can be represented at up to the highest resolution, the zooming being implementable in a continuously variable manner via interactive selection of the image region and determination of a representation size by the user (13).

7. The virtual microscope system as recited in claim 5, wherein the application software (11) includes a tracker which is represented in the total view of the preparation, clarifies the position and expansion of the represented detailed view, and is manually settable, shiftable, and dimensionable by the user (13) for selecting the image region and for manual sampling of the virtual profile (212), thereby selecting a new detailed view.

8. The virtual microscope system as recited in claim 1, wherein the digital image data (31) supplied by the recording system is available in any image data format and can be imported by the software (231) for generating the virtual profile (212), the color depth being variably definable.

9. The virtual microscope system as recited in claim 1, wherein the virtual profiles (212) stored in the case database (222) include, in addition to the image data, other data (32) able to be input by a user (13) of the recording system and/or a client system (1), in particular status data of the case, recording parameters, preparation data, and/or the like, all data being available in a SQL structure in particular.

10. The virtual microscope system as recited in claim 1, wherein the server system (2) also includes a software (232) for image processing of the virtual profiles (212).

11. The virtual microscope system as recited in claim 10, wherein the software (232) for processing virtual profiles (212) includes image processing functions, in particular contrast improvement; normalization of the brightness distribution; white balancing; edge extraction; matching to known structures for the preselection of regions of interest; recognizing, measuring, and counting objects and structures, and/or other functions.

12. The virtual microscope system as recited in claim 10, wherein a simulation of illumination situations, in particular a simulation of at least one bright field and/or dark field, and/or polarization and/or incident light and/or phase contrast or the like, is/are implemented as image processing functions.

13. The virtual microscope system as recited in claim 10, wherein a simulation of color situations, in particular generation of mixed colors as a combination of real colorings and/or color change is/are implemented as image processing functions.

14. The virtual microscope system as recited in claim 10, wherein one or more image processing functions of the software (232) is automatically implementable as a function of the case type or individually by a user (13) following creation of the virtual profile (212).

15. The virtual microscope system as recited in claim 13, wherein the access control includes means for encoding/decoding and/or means for checking access authorization (digital signature).

16. The virtual microscope system as recited in claim 15, wherein a conference mode is possible between the client systems (1).

17. The virtual microscope system as recited in claim 16, wherein a control change, in particular a master-slave assignment, is possible between the client systems (1 and/or the client system (1) and the server system (2).

18. The virtual microscope system as recited in claim 1, wherein the server system (2) includes means (211, 221) for controlling the access of users (13) to the server system (2).

19. The virtual microscope system as recited in claim 18, wherein the means (211, 221) for controlling access include a user database (221) including stored user data, access rights, and allocations to cases and the like as well as access data (211).

20. The virtual microscope system as recited in claim 1, wherein the at least one client system (1) includes a client interface (15) and the server system (2) includes a server interface (25), which are TCP/IP interfaces in particular, and communication between the client system (1) and the server system (2) is implementable via the interfaces (15, 25) and intranet or Internet, a plurality of client systems (1) also being able to access the server system (2) at the same time.

21. The virtual microscope as recited in claim 1, wherein a client system (1) is installed together with the server system (2) on a computer station.

22. The virtual microscope system as recited in claim 1, wherein the application software (11) is provided within a Web browser (111) of the client system (1) by the server system (2).

23. The virtual microscope system as recited in claim 1, wherein the application software (11) is provided as an independent program interface in the client system (1) or within a program interface of another software in the client system (1).

24. The virtual microscope system as recited in claim 1, wherein means for allocating data of virtual profiles (212) to users (13), case status, case data, and data of the virtual profiles (212) are provided in the server system (2).

25. The virtual microscope system as recited in claim 1, wherein the server system (2) and/or the at least one client system (1) include(s) means for generating multi-layer images from a plurality of superimposed virtual profiles (212) of the same preparation, measured using different colorings and/or recording techniques.

26. The virtual microscope as recited in claim 25, wherein the generation of multi-layer images as well as the combining of a plurality of partial images to form one total image is supported by automatic geometric matching.

27. The virtual microscope system as recited in claim 25, wherein a plurality of layers can be represented at the same time by dividing the detailed view, switching the detailed view, or using semi-transparent representation, the degree of transparency being adjustable.

28. The virtual microscope system as recited in claim 27, wherein a plurality of detailed views can be represented at the same time.

29. The virtual microscope system as recited in claim 28, wherein the detailed views can be displayed at different magnifications and/or with different colorings and/or at different locations and/or in different zoom representations.

30. The virtual microscope system as recited in claim 1, wherein the server system (2) and/or the at least one client system (1) include(s) means for generating a marking plane superimposed on the image data of the virtual profile (212), image coordinate-based comments, markings, and/or the like being able to be made by the user (13) on this marking plane and integrated with the virtual profile (212) and stored in the case database.

31. The virtual microscope system as recited in claim 30, wherein the marking plane includes a marking of the image regions viewed by the user (13) during analysis of a virtual profile (212) and/or of an inspection path representing the path through the preparation inspected by the user (13).

32. The virtual microscope system as recited in claim 1, wherein the application software (11) includes image processing functions, in particular contrast improvement, normalization of the brightness distribution, white balancing, edge extraction, matching to known structures for preselection of regions of interest, measuring and counting of structures, and/or additional functions.

33. The virtual microscope system as recited in claim 1, wherein a virtual profile (212) includes retrievable tracking data including the processes and information relating to the virtual profile (212) and continuously logged along the entire workflow, in particular the current status, user (13), process, and the like.

34. The virtual microscope system as recited in claim 1, wherein the digital image data (31) of the preparation provided by the image recording system and the virtual profile (212) generated on the server side are an image of the preparation made up of sub-regions.

35. The virtual microscope system as recited in claim 1, wherein the image sources are digital profiles, imported digital images, PACS (picture archiving and communication system) images, live images (remote-controllable microscope with camera), or the like.

36. A method for processing digital microscope data,
a. Digital image data (31) of a preparation being scanned at a definable magnification and in a definable section by an image recording system or being otherwise imported,
b. A virtual profile (212) of the preparation being generated via a first software (231) of a server system (2) from the digital image data (31) which is provided by the image recording system or is otherwise imported,
c. The virtual profile (212) being modified using a second software (232) and image processing functions,
d. The virtual profile (212) being stored in a case database (222) of a storage device (21),
e. Data of a selected virtual profile (212) of the case database (222) selected by a user (13) being displayed via an application software (11) of the at least one client system (1),
wherein the digital image data (31) of the preparation is scanned by the image recording system at the highest available or desired magnification and in the greatest available or desired section of the preparation and provided to the server system (2), and the server system (2) generates a virtual profile (212) of the preparation from the digital image data (31) at the highest available or desired magnification and in the highest available or desired section of the preparation.

37. The virtual microscope system as recited in claim 36, wherein the greatest available or desired section of the preparation is a total view of the preparation.

38. The virtual microscope system as recited in claim 36, wherein the digital image data (31) provided by the image recording system is reformatted in a compressed image format, in particular enhanced compressed wavelet format (ECW) via the first software (231) for generating virtual profiles (212), and the virtual profiles (212) are stored in the compressed image format in the case database (222).

39. The virtual microscope system as recited in claim 36, wherein in each case exactly one image region of the selected virtual profile (212) selected by the user (13) is requested from the case database (222) of the server system (2) at a compression level corresponding to the selected resolution or is loaded from a mobile data carrier and displayed.
